(19) United States
(12) Patent Application Publication
(10) Pub. No.: US 2023/0169860 A1
(43) Pub. Date: Jun. 1, 2023

(54) SYSTEM AND METHOD FOR TRACKING VEHICLES

(71) Applicant: Avinash Vijai SINGH, Manorhaven, NY (US)

(72) Inventor: Avinash Vijai SINGH, Manorhaven, NY (US)

(21) Appl. No.: 17/994,924

(22) Filed: Nov. 28, 2022

Related U.S. Application Data
(60) Provisional application No. 63/283,717, filed on Nov. 29, 2021.

(51) Int. Cl. G08G 1/0967; G08G 1/01; G08G 1/005; G08G 1/07

(52) U.S. Cl. CPC G08G 1/096783; G08G 1/0116; G08G 1/005; G08G 1/07

(57) ABSTRACT

There is a system and a process for tracking vehicles and individuals in a region during an emergency situation comprising at least one server having at least one microprocessor. There is at least one remote electronic device having at least one processor at least one transceiver and at least one GPS transceiver, there is at least two pressure sensitive sensors to determine a rate of movement of vehicles through an intersection. When the system determines an emergency situation via at least one of the pressure sensitive sensors, the system is configured to notify at least one individual adjacent to the two pressure sensitive sensors. Alternatively, the system could be notified by an emergency responder of an emergency situation.

### CROSS REFERENCE TO RELATED APPLICATIONS

This application is a non-provisional application that claims priority to provisional application Ser. No. 63/283,717 filed on Nov. 29, 2021 the disclosure of which is hereby incorporated herein by reference in its entirety.

### BACKGROUND OF THE INVENTION

At least one embodiment of the invention relates to a system and method for tracking vehicles and for notifying adjacent drivers as well as pedestrians. Currently there is a need for a system to track vehicles through traffic and to direct traffic such that accidents can be avoided during an emergency situation.

### SUMMARY OF THE INVENTION

There is a system and a process for tracking vehicles and individuals in a region during an emergency situation comprising at least one server having at least one microprocessor. There is at least one remote electronic device having at least one processor at least one transceiver and at least one GPS transceiver for allowing for positional tracking. There are at least two pressure sensitive sensors to determine a movement of vehicles through an intersection. When the system determines an emergency situation via at least one of the at least two pressure sensitive sensors, the system is configured to notify at least one individual adjacent to at least one of the at least two pressure sensitive sensors. Alternatively, the system could be notified by an emergency responder of an emergency situation. Thus, there is created a system and process for determining an emergency situation and for also transmitting a state of an emergency situation and for controlling traffic flow and notifications of the emergency situation.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1A is a flow chart disclosing the process for tracking emergency vehicles during an emergency situation;

FIG. 1B is a flow chart which is an expansion of the steps shown in FIG. 13 in FIG. 1A;

FIG. 2 is a schematic block diagram of an intersection involving an emergency vehicle;

FIG. 3 is a network layout of the system;

FIG. 4A is a schematic block diagram of the layout of the portable electronic device used in the system;

FIG. 4B is a layout of a server for use with the system;

FIG. 4C is a schematic block diagram of the layout of a streetlight and/or a crosswalk indicator;

FIG. 4D is a schematic block diagram of the layout of a sensor;

FIG. 4E is a schematic block diagram of a hydrant electronic device; and

FIG. 5 is a more complicated schematic block diagram of a series of intersections and defined areas;

FIG. 6 is a three-dimensional view of an intersection;

FIG. 7 is a schematic plan view of a parking lot with sensors; and

FIG. 8 is a view of an auto with sensors.

### DETAILED DESCRIPTION OF PREFERRED EMBODIMENTS

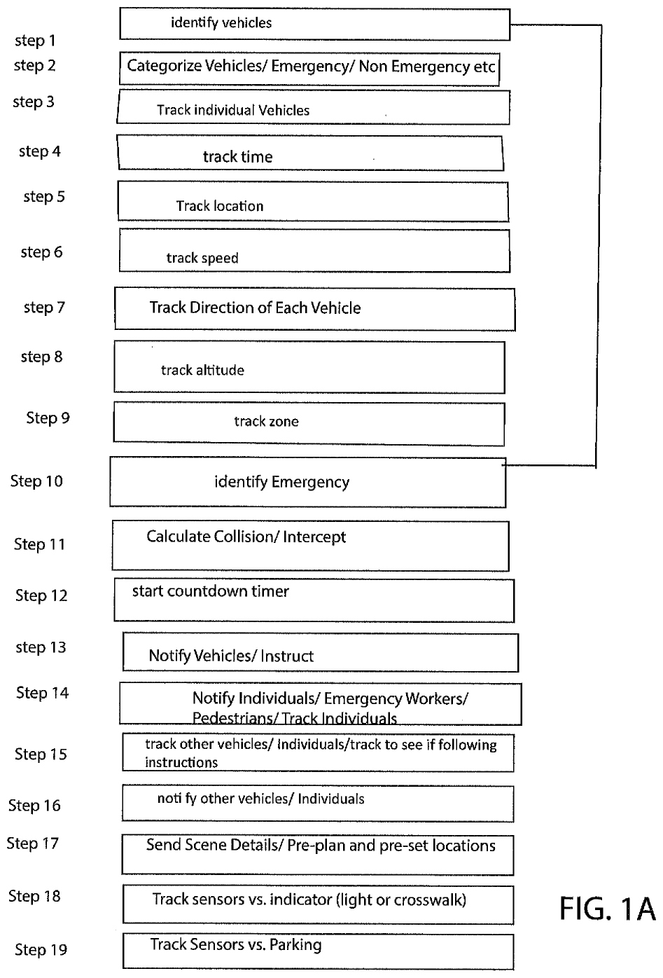

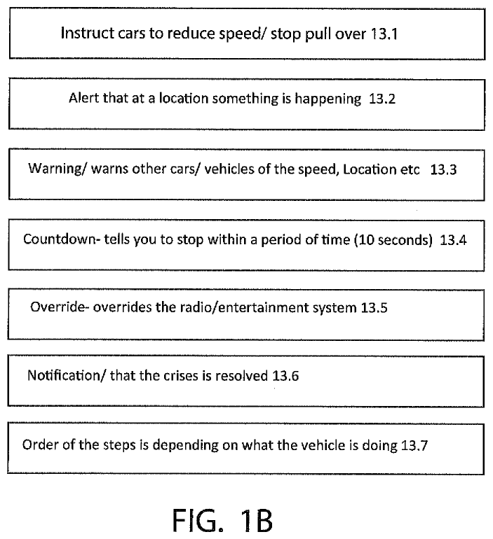

Referring to the drawings, FIG. 1 shows a process for tracking individual vehicles during an emergency situation. For example, the process starts in step 1 wherein the system registers and identifies individual vehicles. In all cases there is an optional opt-in to the system wherein individuals can voluntarily opt in to be tracked and to receive emergency notifications via their handheld device such as device 44 shown in FIG. 3. However, if the system determines that there is an emergency situation in a particular area as shown in step 10 then the system can broadcast and track all vehicles and pedestrians regardless of enrollment as well. Thus, with the occurrence of an emergency situation, the process can revert from step 10 back to step 1 to automatically identify vehicles in an emergency situation and broadcast the presence of this situation.

Next, in step 2 the system categorizes the vehicles as emergency vehicles or non-emergency vehicles. An emergency vehicle can also have further categorizations such as Ambulance, Fire Truck, Police vehicles, Military vehicles, HAZMAT vehicles etc. The categorization of the vehicles can then lead to a different set of instructions presented to the vehicle based upon the type of emergency situation as well as the type of vehicle.

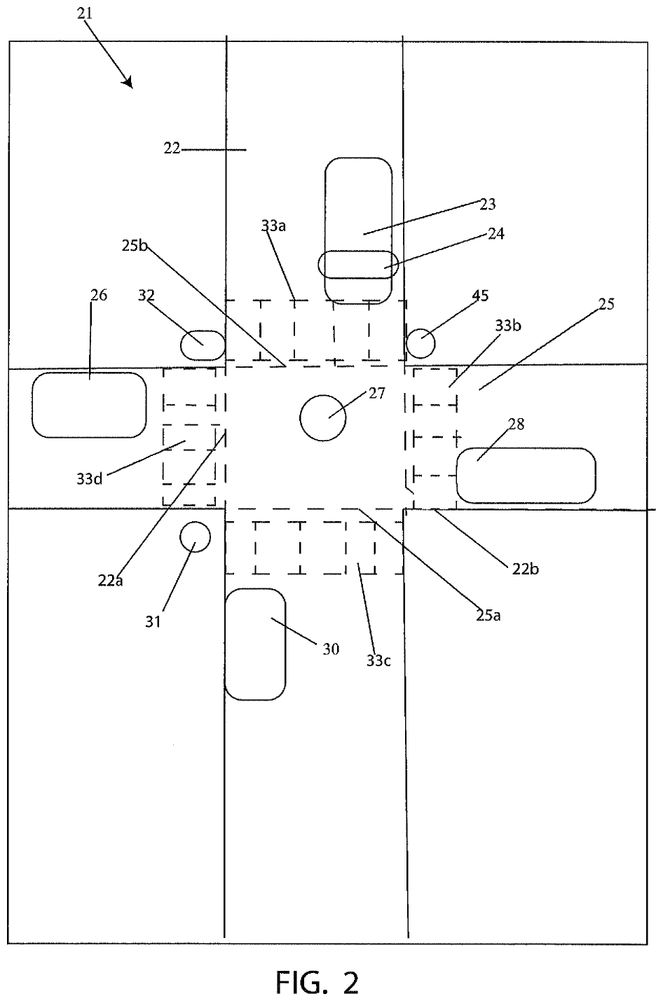

Next, the system tracks each of these vehicles in step 3. Once the vehicles are identified, and categorized, they are tracked for location on a grid or area map. For example, the system starts to track the time in step 4, and the location of each of these vehicles (See FIG. 2) in step 5. Next in step 6 the system tracks the speed of each of these vehicles. Next, in step 7 the system tracks to direction of each vehicle. Next in step 8 the system tracks the altitude of each of these vehicles. Each of these components can be tracked or be initiated in tracking asynchronously, that is they can be tracked in any order.

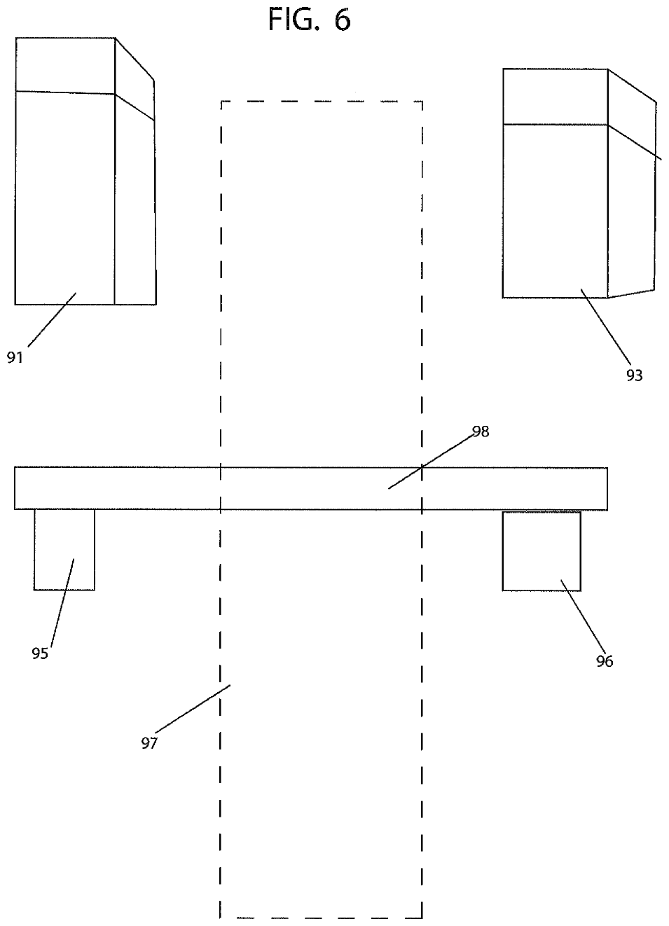

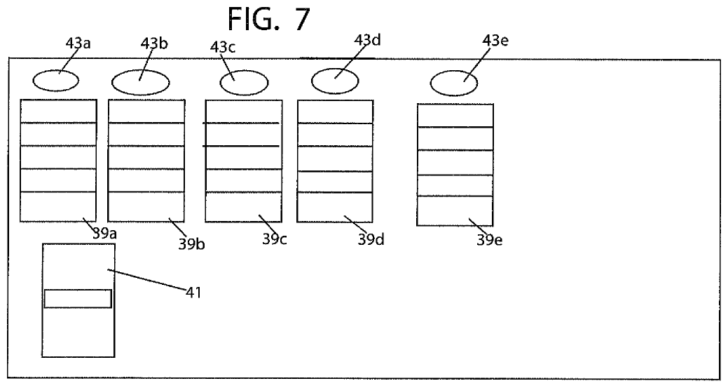

The tracking of the altitude (See FIG. 6) is important because it helps to determine whether the vehicle is in a parking garage, whether an individual is in a building, whether a vehicle is on a bridge or in a tunnel. The altitude can be inferred from the GPS coordinates as well as knowledge of the topographical layout of the area map.

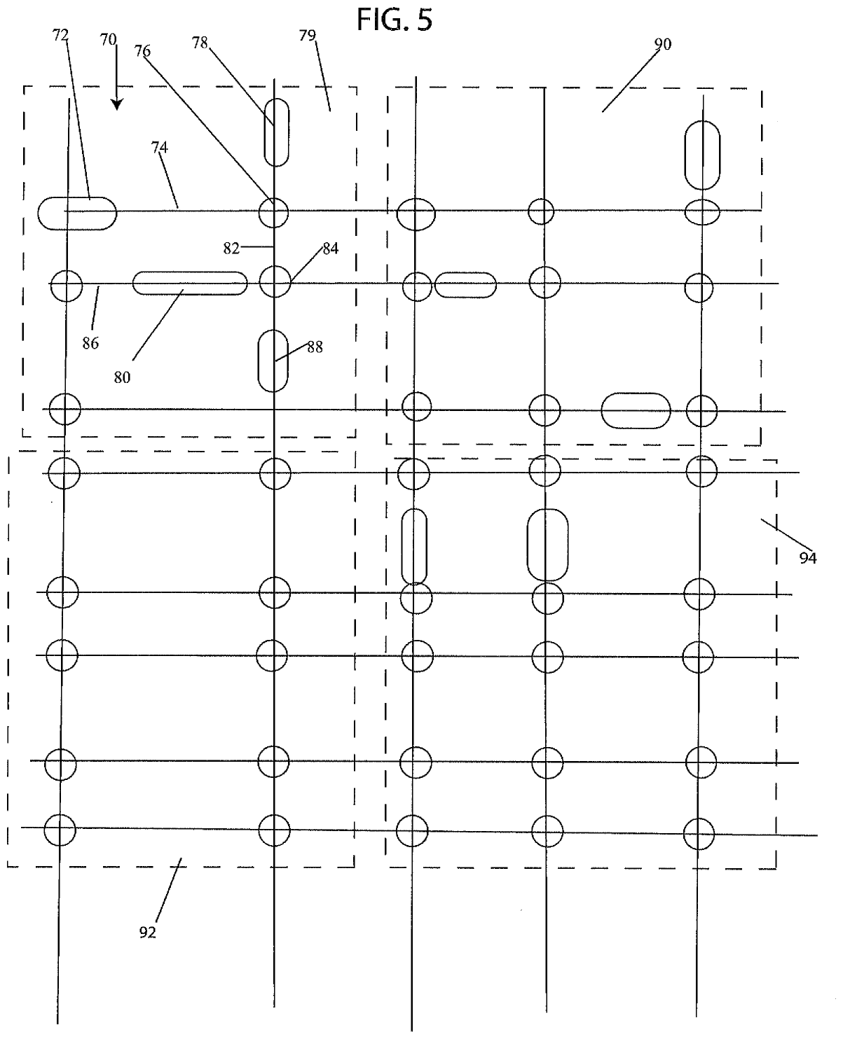

Next, in step 9, the system can track particular zones (See FIG. 5) such that certain zones would be highlighted if there is an emergency situation in a particular zone. Each zone is a particular area for observation, which can comprise a grid of streets for analyzation. Other zones adjacent to the zone of the emergency may be highlighted and tracked but the vehicles and pedestrians in these zones would receive a different notification than the pedestrians and vehicles in the zone of the emergency.

Upon the occurrence of an emergency, the emergency would be identified and then categorized in the system. One way to identify an emergency is if an emergency first responder notifies the system of an emergency. For example, if there is a fire, the first responder system for fires would notify the address, type of fire, and time of origin of the fire to the system. Alternatively, the emergency situation could be a high-speed car, which is identified by police and then the information is sent into the system.

Alternatively, as shown in FIG. 2 the system could have sensors such as sensors 25a and 25b or 22a and 22b which are pressure sensors and track the speed of vehicles over these sensors by identifying the weight on these sensors, and then determining the time separation between the crossing of each of these sensors to determine based upon the distance between these sensors the speed of the vehicle. If the vehicle is operating an exceptionally high speed, then the system could automatically notify other emergency systems of an emergency situation.

Next, in step 11 the system can determine the potential occurrence of a collision or intercept of two different vehicles or pedestrians. This calculation is performed based upon the location of each vehicle, the direction of each vehicle, the nature or shape of the road, the speed of each vehicle and the traffic conditions.

Upon the identification of each emergency in step 10, and the potential for collision in step 11, the system can start a countdown timer in step 12 to determine the potential or time for impact of a vehicle or individual and vehicle collision. Based upon the time for potential impact, the system can in step 13 then notify adjacent individuals and vehicles of the potential for collision or interactions and then provide instructions to these vehicles in step 13, or provide instructions to the pedestrians in step 14. The instructions could be in the form of controlling a traffic signal to change a state of the traffic signal or to control or change a state of the crosswalk indicator, or to send instructions directly to the individuals via their portable electronic devices such as a cellular telephone or handset. The changing of the state of the traffic signal could be in changing the signal from green to red, or green to yellow or red to yellow or yellow to red. In this way the traffic signal could control the flow of traffic to facilitate certain vehicles moving towards or away from an emergency situation.

Next, in step 15 the system can track other vehicles outside of the particular emergency zone to determine whether these vehicles may enter into that particular emergency zone. Next, in step 16 the system can notify other vehicles such as emergency vehicles and nonemergency vehicles to warn these vehicles of an impending emergency.

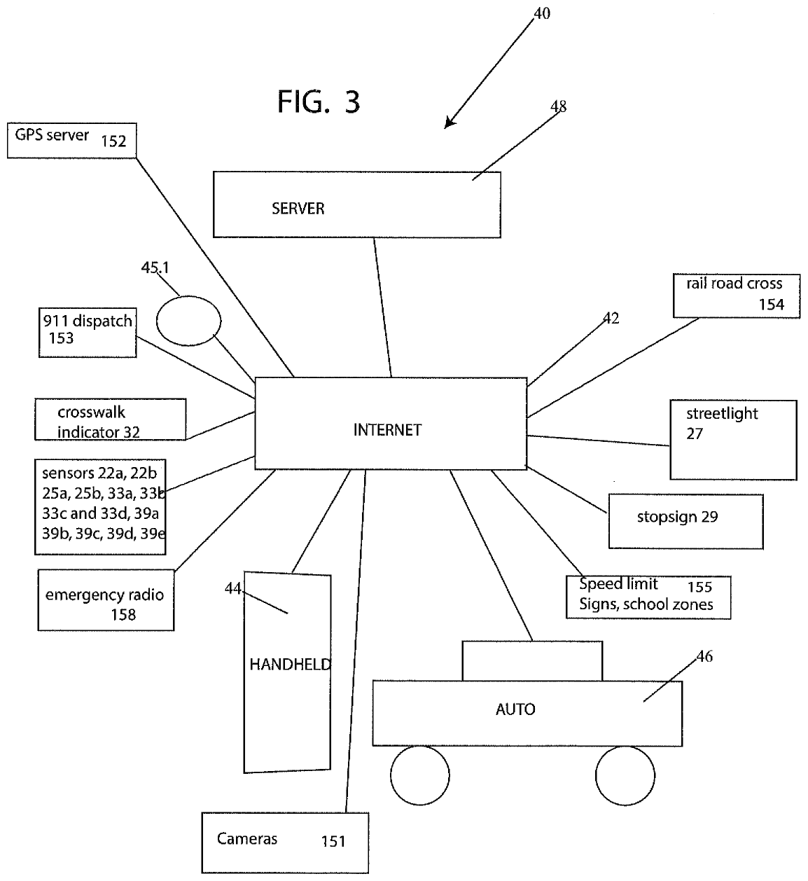

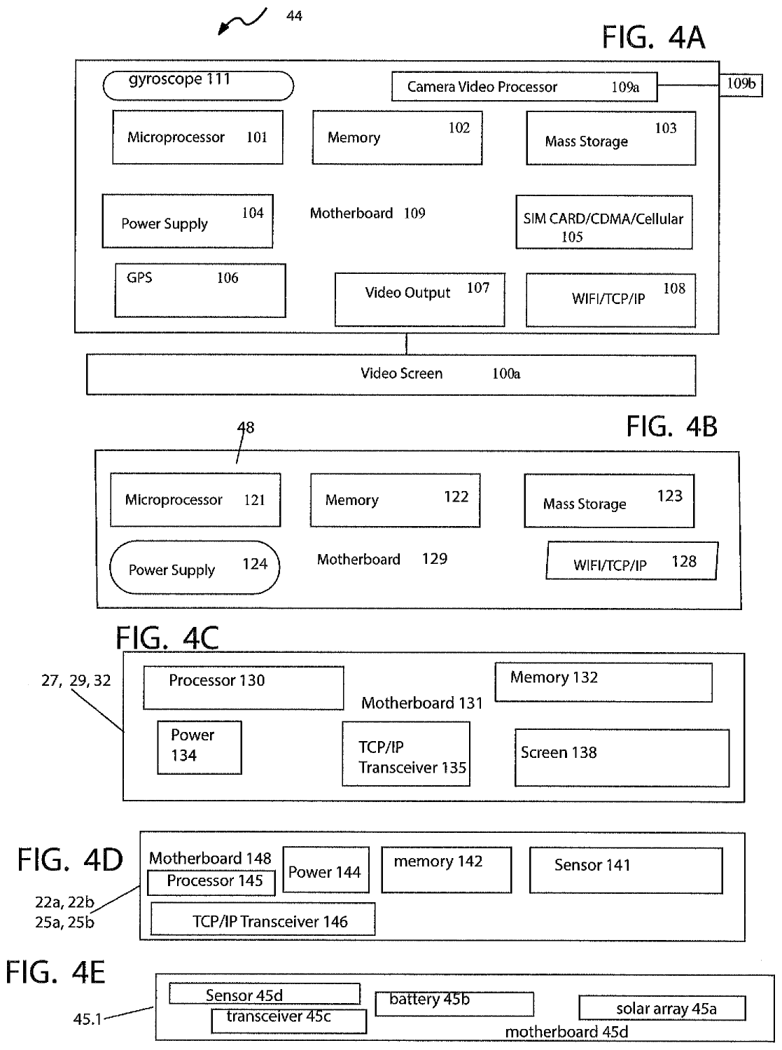

Step 17 involves sending scene details to the responders via an electronic transmission from the server to the remote portable electronic devices. These scene details include layout of the area (map, and the staging of vehicles such as shown in FIG. 2). The scene details for the emergency situation can include location of a hydrant (See hydrant 45 FIG. 2). In this way, the system can send a pre-plan as well as live updates to the location of vehicles on the scene so that other late arriving vehicles can know what resources are there, as well as the location of stationary resources such as hydrants. The system can also track whether first responders have left a vehicle by tracking the location of their handheld devices vs. the location of their vehicle. Thus, for example, each vehicle can contain a portable device much like the handheld devices 44 shown in FIG. 4A so that both the vehicle and each responder can be tracked.

Step 18 involves tracking sensors such as sensors 22a, 22b, 25a, 25b and 33a, 33b, 33c, and 33d and determining whether an auto or a pedestrian has crossed a street or a crosswalk and then determining the state of an adjacent light or crosswalk indicator such as indicator 32 or light 27. In this way, if an auto has crossed the sensor such as sensor 22a, while the light 27 is indicating a “red” light, then the system can determine whether an auto has just run a red light. In addition, if an auto is crossing through a region while a pedestrian is crossing on a cross-walk by tripping the sensors such as sensors 33b then the system can determine whether there is the presence of an auto through an intersection thereby creating an otherwise dangerous situation. The server such as server 48 would then send out a notification of either a traffic infraction of the presence of a dangerous situation, which may result in an emergency situation identified in step 10. For example, if the system determines that there is a dangerous situation in step 18, it could immediately proceed to an automatic determination of an emergency situation in step 10. In that case, the system could then actively track all of the parties in that region. Alternatively, if the system determined that there was the potential for an emergency situation created by the presence of a likely dangerous situation, then the system could immediately jump back to step 1 and actively track pedestrians and vehicles in a particular zone to determine whether a dangerous situation has resulted in an actual emergency situation, thereby resulting in the ultimate notification of adjacent pedestrians and vehicles of this emergency situation in step 13. In this case, with the determination of a dangerous situation or an emergency situation, the system such as server 48 can then also notify a stop sign such as stop sign 29 to indicate of the presence of a dangerous situation. In this way the stop sign can light up and indicate of this dangerous situation. Step 19 involves tracking the parking of vehicles in parking spots, such as spots shown in FIG. 7.

FIG. 1B is a flow chart which is an expansion of the steps shown in FIG. 13 in FIG. 1A. For example, this flow chart discloses that step 13 in FIG. 1A is actually multiple different steps. For example, the steps of notifying a vehicle can include step 13.1 which includes instructing the cars/autos to reduce speed, stop or pull over in step 13.1. Next or simultaneously (either shortly before, during or after step 13.1), in step 13.2 the system can alert that at a location something is happening. Next, simultaneously in step 13.3 they system can issue a warning to other cars to reduce or vary the speed, change direction or change location. Next, in step 13.4 simultaneously, the system can issue a countdown to tell users to stop within a period of time (such as 10 seconds). Next, in step 13.5 the system can simultaneously when issuing these instructions override the radio/entertainment system. Next, in step 13.6 the system can simultaneously issue a notification that a crises is resolved. Next, in step 13.7 the system vary the order of the steps listed above depending on what the vehicle is doing. The system is basically server 48 in communication with all of the other components shown in FIG. 3.

FIG. 2 is a schematic block diagram of an intersection 21. In this view, there is a first road 22 which has an emergency vehicle 23 having emergency lights 24. There is a second road intersecting the first road 22, wherein the second road 25 is substantially perpendicular an extension from road 22. In the central region there is a streetlight 27 for directing traffic. This streetlight is connected to a computer network so that it can communicate with a server such as server 48.

A plurality of vehicles 26 and 28 are shown on this road 25 there is also another vehicle 30 in an opposite oncoming lane from the emergency vehicle 23. Thus, with this typical intersection, if an emergency were to occur, the system could notify both the emergency vehicle 23, as well as the adjacent vehicles 26, 28 and 30. In addition, the system could also control the streetlight 27 to control whether the streetlight allows traffic through or stops all traffic. In this way, the system could function as a way to organize traffic around emergency in a dynamic manner. This system also includes sensors 22a and 22b which are pressure sensors. Pressure sensors 22a and 22b are configured to identify a vehicle based upon the weight of the vehicle. This information is then relayed back to the server such as server 48. The server 48 can then calculate the speed of the vehicle crossing these sensors 22a and 22b by first calculating the time that the vehicle takes to cross each of these sensors, and then recalls the distance between each of these sensors (distance is pre-recorded and stored in database). With the time for crossing each sensor and the distance between each sensor, the system can track each vehicle crossing based upon the identification of each vehicle based upon weight. For example, if a vehicle 26 weighed 2500 pounds and vehicle 28 weighed 5000 pounds, the system having sensors recording these weights would be able to differentiate between these two vehicles and individually record the speed of each vehicle as it crosses the sensor lines.

Additionally, sensors 25a and 25b are also positioned along a road in another direction so as to perform these same type of calculations.

There is also a hydrant 45 which is configured to be in communication with the server such as server 48. This hydrant 45 can then relay information and be in communication with server 48 via a TCP/IP network such that the state of the hydrant can be sent to the server to update the server on whether the hydrant is being used.

There is also a pedestrian 31 shown on the street corner looking to cross through a cross-walk having cross walk sensors 33d. There are a plurality of cross-walk sensors 33a, 33b, 33c, and 33d positioned across the two different streets or roads 22 and 25 to detect whether pedestrians are crossing the street. These sensors are in communication with server 48. Essentially server 48 is configured to determine whether an auto is crossing through an intersection and whether a pedestrian is crossing a street.

Thus, the system can automatically determine an emergency situation when a vehicle is travelling above a speed limit or out of an ordinary pre-defined situation. For example, the system could be configured to notify a surrounding area of an emergency if a vehicle was travelling 25 miles an hour or more above a pre-defined speed such as a speed limit. Alternatively, this amount above the speed limit could be 30 miles an hour or some other trigger point. Once the pre-defined speed is exceeded, the system could then start tracking all vehicles in a region of this emergency trigger situation. The time of day of the occurrence as well as the distance that the vehicle travels at this speed, the topography of the road as well as the weather conditions could also be a factor in setting the pre-defined speed limit to cause a triggering of an emergency situation. The location of this occurrence could also be a factor such as the location of the occurrence to a hospital, school or park, etc.

FIG. 3 is a schematic block diagram of the computer network 40 for the system. For example, there is a server 48, the Internet 42, at least one handheld device 44, at least one motor vehicle 46. The system can be configured to track handheld devices 44, automobiles or motor vehicles 46, or any other suitable portable electronic device. This view also shows a hydrant electronic device 45.1 which is coupled to a hydrant 45 (see FIG. 2) as well as a stop sign 29 which can also communicate with server 48. There are also sensors 22a, 22b, 25a, 25b, 33a, 33b, 33c, 33d, 39a, 39b, 39c, 39d, and 39e which are in communication with the internet 42 and which are also in communication with server 48 as well. The other components that are in communication with server 48 through the internet 42 include a rail road crossing (control) 154, a streetlight 27, a speed limit indicator 155, an automobile or motor vehicle 46, a camera 151, a handheld device 44, an emergency radio 158, a crosswalk indicator 32, a 911 dispatch 153, and a GPS (satellite location) server 152. All of these components are part of the computer network 40. These components can act as sensors or communication devices to identify an emergency and also be used as devices for communication and controlling the flow of traffic (automobile or people) during an emergency situation.

FIG. 4A is a schematic block diagram of a portable handheld device such as a cell phone or tablet. Each of these cell phones or tablets or handheld devices 44 are configured to communicate with a server such as server 48.

The portable electronic devices include a microprocessor 101, a memory 102, a mass storage or hard drive, which could also be a flash memory 103, a power supply 104 a sim card 105, a GPS transceiver 106, a video output 107, a WIFI transceiver 108, as well as a gyroscope 111, and a video screen 100a. All of these components are in communication with each other via a motherboard 109. In at least one embodiment, the portable device is configured such that if the microprocessor 101 determines that the speed of the handheld device 44 is exceeding a pre-defined limit then this speed is recorded in the short-term memory 102, and then eventually transmitted into the long-term memory 103 or transmitted to server 48 to record this speed over time.

The server 48 includes a microprocessor 121, a memory 122, a mass storage 123, a power supply 124, and a WIFI/TCP/IP transceiver 128. The microprocessor 121 is configured to perform many if not all of the steps shown in FIG. 1. In particular, microprocessor 121 is configured to receive all of the information from the sensors 22a, 22b, 25a and 25b as well as send communications to the different streetlights such as streetlight 27 and cross walks such as cross walk indicator 32 through TCP/IP transceiver 128. The sensors 22a, 22b, 25a and 25b are in the form of piezoelectric sensors which sit below a road surface but when compressed send a signal which not only indicates compression, but also indicates the amount of compression, thereby indicating the weight of a moving vehicle. As shown in FIG. 3, these sensors are in communication with the internet 42, in an either wired or wireless manner such that they communicate this information to the internet 42 and then on to server 48 so that microprocessor 121 can perform its intended calculations.

FIG. 4C is a schematic block diagram of either the streetlight 27 or the crosswalk indicator 32, or a stop sign 29. This design includes a motherboard 131, a processor 130, a memory 132, a power indicator 134, a TCP/IP transceiver 135 and a screen/indicator 138. The screen/indicator can be a Walk/Stop indicator for a crosswalk indicator 32 or a series of LED lights for Red, Green or Yellow for a traffic light. Alternatively, the indicator 138 can be used to light up LED lights on a stop sign to indicate that all traffic must stop.

FIG. 4D is a schematic block diagram of the sensor 22a, 22b, 25a or 25b for detecting motor vehicles and for identifying these motor vehicles. This sensor can include a piezoelectric sensor 141 as well as a memory 142, a power supply 144 and a TCP/IP transceiver 146 positioned on a motherboard 148. The sensor 141 receives pressure from an automobile, this pressure creates an instance of a contact with an auto or moving vehicle which then sends a signal through motherboard 148 which is in relation to the pressure placed on the sensor. The information is buffered or stored in memory, read by processor 145 and then this information is sent by transceiver 146 either wirelessly or in a wired manner to the internet 42 and then eventually on to server 48.

Server 48 already has a pre-recorded distance between the two sensors 22a and 22b and 25a and 25b so that the time between interactions of the motor vehicle can then be used to determine the speed of the motor vehicle through an intersection or across a distance in a road. Alternatively, the server such as server 48 can be used to track the location of a user and a speed of the user via the location of the user's handheld device 44 such as through tracking of the GPS 106.

FIG. 4E is a view of a hydrant electronic device. This device 45.1 includes a solar array 45a to provide power to the device. There is also a battery 45b to store power from the solar array. There is a transceiver 45c which includes a microprocessor embedded therein and which is configured to transmit a state of the hydrant. In addition there is a sensor which is configured to indicate that the hydrant is in use by at least one responder, which is the state of the hydrant. The hydrant electronic device 45.1 is configured to be coupled to a hydrant 45.

FIG. 5 is a schematic block diagram of a series of zones or areas 70, 90, 92 and 94. In a first zone 70, there are a plurality of vehicles 72, 78, 80 and 88 positioned on different roads 74 82 and 86 and controlled by different traffic lights 76 and 84. The control of the traffic lights would be to control traffic during an emergency situation and to control the passage of non-emergency vehicles separate from emergency vehicles. As shown if there is an emergency in a first zone 70, the system can control the traffic lights and notify all of the vehicles in that area. However, it could also monitor and control (if necessary, the traffic and flow of emergency vehicles in adjacent areas such as in areas 90, 92, and 94.

FIG. 6 is a three-dimensional view of an intersection having a parking garage 91, an office building 93, a bridge 98 having pilings 85 and 96 as well as a road 97. If the people or the autos are elevated above an intersection involved in an emergency situation, then these autos or people could be notified but if they are on a different elevation, then they could or would receive a different notification than the parties which are on the same elevation as the emergency. This system could also apply to tunnels, mountainsides or other topographical configurations which may aid a first responder or emergency management system in identifying unusual situations.

FIG. 7 is a view of a parking lot with sensors, the sensors 39a, 39b, 39c, 39d, and 39e are positioned in a lot in a parking spot. When an auto such as auto 41 positions itself in the spot, it pressed down on a pressure sensor such as any one of sensors 39a, 39b, 39c, 39d and 39e sending a signal to the server indicating the presence of an auto in the region of the parking spot (see step 19 in FIG. 1). The parking meter such as any one of parking meters 43a, 43b, 43c and 43d, or 43e associated with their respective sensors 39a, 39b, 39c, 39d, 39e are configured to indicate the rate and time that the auto is on the meter. A person associated with the auto 41 can then communicate with their respective handheld device 44 to pre-pay an amount of time or to simply pay for the amount of time the auto sits on the sensor for the parking space and then have this pre-paid time or running time show up on the associated parking indicator 43a, 43b, 43c, 43d, or 43e. Thus, the server 48 would continuously toll the time that the auto was present on the sensor and then continuously charge the user via their handheld device 44 for the amount of time that the user was on his/her respective spot.

In all any one of the sensors or electronic devices can operate using cellular, WIFI, Bluetooth, or nearfield communication. The sensors in particular, can include black box technology that saves the actions and or history of the activity right in that location. Each of the automobile sensors can have associated with it or even the cellular telephones of the drivers can have associated with it an identity that includes the driver's license, VIN (Vehicle identification number) as well as insurance information. Therefore, the system can know the driver's license status and insurance status as well as inspection status of each vehicle or driver. In addition, each of these devices or sensors can connect to other outside sensors of devices that are wearable devices such as heart-rate monitors or other medical monitoring systems which update the server such as server 48 of the condition of pedestrians or drivers. This system can also be used to enforce parking situations such that an alarm would go off if the user parked in front of a hydrant, or in an illegal spot. For example, if the hydrant sensor had a Bluetooth communication device or a near field communication device it could communicate with the user's auto sensor or the user's cellular telephone or handheld device to warn the user that they are potentially parking illegally.

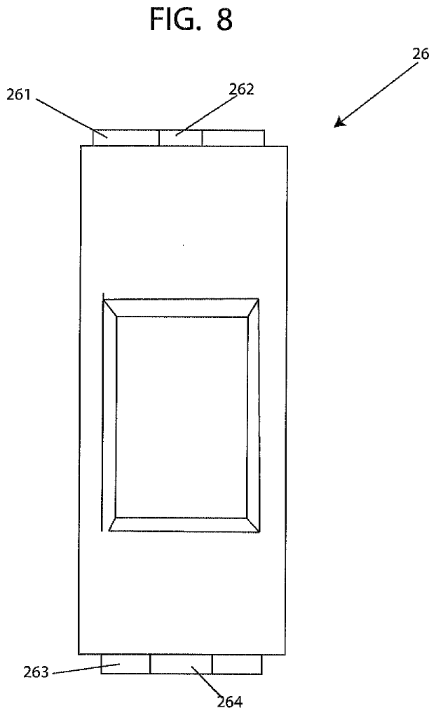

In addition, as shown in FIG. 8 automobiles such as auto 26 can have impact sensors 262 and 264 in bumpers 261, and 263 respectively. These impact sensors can communicate through the internet to server 48 so that if there is an impact it can be immediately communicated to the system.

Accordingly, while at least one embodiment of the present invention have been shown and described, it is to be understood that many changes and modifications may be made thereunto without departing from the spirit and scope of the invention as defined in the appended claims.

What is claimed is:

1. A system for tracking vehicles and individuals in a region during an emergency situation comprising:
at least one server having at least one microprocessor;
at least one remote electronic device having at least one processor at least one transceiver and at least one GPS transceiver; and
at least two pressure sensitive sensors to determine a movement of vehicles through an intersection;
wherein when the system determines an emergency situation via at least one of said at least two pressure sensitive sensors, the system is configured to notify at least one individual adjacent to at least one of said at least two pressure sensitive sensors.

2. The system as in claim 1, wherein the system is configured to record a movement of said at least one remote electronic device once the system determines that there is an emergency situation.

3. The system as in claim 2, wherein the system notifies the remote electronic device of an emergency via a message.

4. The system as in claim 3, wherein the message is a SMS message.

5. The system as in claim 3, wherein the message is an emergency notification.

6. The system as in claim 3, wherein the message is an alarm.

7. The system as in claim 1 further comprising at least one traffic light in communication with said at least one server.

8. The system as in claim 7, wherein during an emergency situation, the server controls a state of the at least one traffic light.

9. The system as in claim 1, further comprising at least one cross walk monitor in communication with said at least one server.

10. The system as in claim 1, wherein the at least one server is configured to control a state of the at least one cross walk monitor.

11. A process for notifying individuals located near an emergency situation comprising the steps of:
determining an existence of an emergency situation via a pre-set condition stored in a memory and determined by a microprocessor;
identifying at least one vehicle in proximity to said emergency situation by identifying via GPS coordinates a location of at least one portable electronic device;
categorizing said at least one identified vehicle;
tracking said at least one identified vehicle for at least one of time, location, speed, elevation, and direction; and
notifying said at least one vehicle of an existence of an emergency by sending via a server a signal to at least one of a traffic indicator or a portable electronic device.

12. The process as in claim 11, wherein said step of notifying said at least one vehicle comprises sending a signal from a server to at least one of a portable electronic device or a traffic indicator notifying the vehicle to change a state of movement.

13. The process as in claim 12, wherein said notification comprises requesting that the vehicle stop movement.

14. The process as in claim 12, wherein said notification comprises requesting that a vehicle changes direction.

15. The process as in claim 12, wherein said notification comprises requesting that a vehicle increases speed.

16. The process as in claim 11, further comprising the step of communicating with at least one traffic signal to change a state of the traffic signal.

17. The process as in claim 11, further comprising the step of communicating with a cross walk indicator to change a state of a crosswalk indicator.

18. The process as in claim 11, further comprising the step of identifying at least one pedestrian, and notifying said at least one pedestrian of the emergency.

19. The process as in claim 18, further comprising identifying at least one area for the emergency situation and then a server notifies each pedestrian and vehicle in the area of the emergency situation.

20. The process as in claim 19, further comprising the step of notifying pedestrians and vehicles in adjacent areas of the emergency situation with a different message than that sent to pedestrians and vehicles in the area of the emergency situation.
